(19) United States
(12) Patent Application Publication
(10) Pub. No.: US 2026/0111382 A1
(43) Pub. Date: Apr. 23, 2026

(54) PCIE EXPANSION CHASSIS, SERVER, METHOD AND APPARATUS FOR CONTROLLING DATA TRANSMISSION, AND PRODUCT

(71) Applicant: Suzhou MetaBrain Intelligent Technology Co., Ltd., Suzhou, Jiangsu (CN)

(72) Inventors: Zhiquan XU, Suzhou, Jiangsu (CN); Dexin LI, Suzhou, Jiangsu (CN); Mingyuan LU, Suzhou, Jiangsu (CN)

(21) Appl. No.: 19/167,718

(22) PCT Filed: Aug. 5, 2024
(86) PCT No.: PCT/CN2024/109726

§ 371 Date: Sep. 22, 2025

(30) Foreign Application Priority Data
Jan. 17, 2024 (CN) 202410064974.X

(51) Int. Cl. G06F 13/40; G06F 11/07

(52) U.S. Cl. CPC G06F 13/4022; G06F 11/0772; G06F 2213/0026

(57) ABSTRACT

The present application relates to the technical field of PCIe, and discloses a PCIe expansion chassis, a server, a method and apparatus for controlling data transmission, and a product. The PCIe expansion chassis includes a switching unit and at least one PCIe slot; the switching unit includes one downstream interface and at least two upstream interfaces; the PCIe slot is used for installing a PCIe device; the downstream interface is used for being connected to the PCIe slot; the at least two upstream interfaces are used for being connected to a CPU on a motherboard side, to form a multi-channel data link; and during data transmission, the switching unit selects any channel in the multi-channel data link for data transmission.

### CROSS-REFERENCE TO RELATED APPLICATION

This application claims priority to Chinese Patent Application No. 202410064974.X, filed on Jan. 17, 2024 in China National Intellectual Property Administration and entitled “PCIe Expansion Chassis, Server, Method and Apparatus for Controlling Data Transmission, and Product”, which is hereby incorporated by reference in its entirety.

### FIELD

The present application relates to the technical field of PCIe, in particular to a PCIe expansion chassis, a server, a method and apparatus for controlling data transmission, and a product.

### BACKGROUND

Peripheral Component Interconnect Express (PCIe) is a peripheral component interconnect express standard that uses high-speed serial communication technology to significantly improve a data transmission rate. In practical applications, based on bandwidth requirements, commonly used PCIe slots include X2, X4, X8, X16, and the like. Different slot rates might support various PCIe devices. With the continuous improvement of PCIe rates, increasingly diverse PCIe devices are supported, leading to a gradual rise in PCIe link problems and an expansion in both the scope and impact of faults. Although some minor error reports, such as Correctable Error (CE), may not have a significant impact on services, serious problems such as Uncorrectable Error (UCE), speed reduction, bandwidth reduction, and even card drop may have a serious impact on the normal operation of services. For example, fatal uncorrectable errors often lead to PCIe link and hardware abnormalities. Such cases require link and hardware device resetting operations, resulting in service interruption.

In daily maintenance of a PCIe device or link, if a quantity of UCE or CE errors in the PCIe link reaches a threshold, fault repair is usually carried out by locating and removing error report devices. The device, which supports hot plugging, might be replaced through a hot-plug button. However, this method might merely solve fault problems caused by devices. When the PCIe link fails, the replacement or initialization of the device cannot directly solve the problems, and system restart is required to try to solve the link problems. However, faulty physical links cannot be recovered even by timely system restart. In such a case, troubleshooting takes a lot of time and seriously affects the normal operation of services. Therefore, how to improve the stability and reliability of PCIe links is a challenging problem that needs to be solved.

### SUMMARY

In view of this, the present application aims to propose a peripheral component interconnect express expansion chassis, a server, a method and apparatus for controlling data transmission, and a product, to improve the stability and reliability of a peripheral component interconnect express link.

To achieve the above objective, technical solutions of the present application are as follows:

A first aspect of some embodiments of the present application provides a peripheral component interconnect express expansion chassis, the peripheral component interconnect express expansion chassis including a switching unit and at least one peripheral component interconnect express slot, and the switching unit including one downstream interface and at least two upstream interfaces, where

the peripheral component interconnect express slot is used for installing a peripheral component interconnect express device;

the downstream interface is used for being connected to the peripheral component interconnect express slot;

the at least two upstream interfaces are used for being connected to a central processing unit on a motherboard side, to form a multi-channel data link;

during data transmission, the switching unit selects any channel in the multi-channel data link for data transmission.

Optionally, a bandwidth of the downstream interface in the switching unit is a sum of bandwidths of all the peripheral component interconnect express slots; and

a bandwidth of any upstream interface in the switching unit is not less than the bandwidth of the downstream interface.

Optionally, bandwidths of all the upstream interfaces in the switching unit are equal.

Optionally, the peripheral component interconnect express slot is one X16 slot or two X8 slots; and

the switching unit includes one downstream interface and two upstream interfaces, where a bandwidth of each upstream interface is equal to a bandwidth of the downstream interface; and the bandwidth of the downstream interface is a sum of bandwidths of all the peripheral component interconnect express slots.

According to a second aspect of some embodiments of the present application, a server is provided, the server including:

at least one peripheral component interconnect express expansion chassis, the peripheral component interconnect express expansion chassis being the peripheral component interconnect express expansion chassis provided in the first aspect of some embodiments of the present application, and the peripheral component interconnect express expansion chassis being a multi-channel peripheral component interconnect express expansion chassis; and

a central processing unit, connected to the upstream interfaces of each peripheral component interconnect express expansion chassis through a plurality of peripheral component interconnect express interfaces on a motherboard side respectively, configured to conduct data communication with the peripheral component interconnect express device on the peripheral component interconnect express expansion chassis, and configured to, when any channel in the multi-channel data link fails, disable the peripheral component interconnect express interface of the channel on the motherboard side.

Optionally, a basic input output system runs on the central processing unit; and the basic input output system is configured to perform the following step: when the server starts, the basic input output system allocates corresponding peripheral component interconnect express resources to at least one channel in each multi-channel data link, where a bandwidth of each channel is not less than a sum of bandwidths of all the peripheral component interconnect express slots in the peripheral component interconnect express expansion chassis.

Optionally, the server further includes:

a baseboard management controller, configured to: when the server starts, perform channel identification on each peripheral component interconnect express expansion chassis; and if the peripheral component interconnect express expansion chassis has a plurality of channels, configure a default channel for the peripheral component interconnect express expansion chassis;

where the switching unit is further configured to preferentially select the default channel for data transmission; and

the basic input output system is further configured to allocate corresponding peripheral component interconnect express resources to all the channels of each peripheral component interconnect express expansion chassis.

Optionally, the baseboard management controller is configured to: when the server starts, determine whether the peripheral component interconnect express expansion chassis has a plurality of channels by identifying an underlying unit FRU of the peripheral component interconnect express expansion chassis; and after the configuration of the default channel is completed, store information of the default channel in an erasable programmable read-only memory.

Optionally, the basic input output system is further configured to perform the following steps when an operating system of the server starts:

detecting whether there is an uncorrectable error in a current channel; if there is the uncorrectable error, determining that the current channel fails; or detecting whether a quantity of correctable errors in a current channel reaches a first threshold; if the quantity reaches the first threshold, determining that the current channel fails; and

when it is determined that the current channel fails, disabling the peripheral component interconnect express interface of the current channel on the motherboard side;

where the switching unit is further configured to switch, based on disable information about the peripheral component interconnect express interface on the motherboard side, to the remaining channels of the data link where the current channel is located for data transmission.

Optionally, the basic input output system is further configured to perform the following steps during the operation of the peripheral component interconnect express device:

continuously reading a register of the central processing unit, and if an uncorrectable error occurs in the register, determining that a current channel fails; or continuously reading a register of the central processing unit, and if a quantity of correctable errors in the register reaches a second threshold, determining that a current channel fails; and

when it is determined that the current channel fails, disabling the peripheral component interconnect express interface of the current channel on the motherboard side;

where the switching unit is further configured to switch, based on disable information about the peripheral component interconnect express interface on the motherboard side, to the remaining channels of the data link where the current channel is located for data transmission.

Optionally, the basic input output system is further configured to generate fault information based on all currently faulty channels, and send the fault information and channel switching information to the operating system of the server and a baseboard management controller;

the operating system of the server records fault logs based on the received fault information and channel switching information; and

the baseboard management controller records fault logs based on the received fault information and channel switching information.

Optionally, the baseboard management controller warns a link fault based on the received fault information.

Optionally, the baseboard management controller is further configured to, if all the channels of the data link fail in the received fault information, determine that a device fault occurs, and warn the device fault.

According to a third aspect of some embodiments of the present application, a method for controlling data transmission is provided, applied to the server provided in the second aspect of some embodiments of the present application. The method includes:

when the server starts, performing channel identification on each peripheral component interconnect express expansion chassis; if the peripheral component interconnect express expansion chassis has a plurality of channels, configuring a default channel for the peripheral component interconnect express expansion chassis;

allocating corresponding peripheral component interconnect express resources to all the channels of each peripheral component interconnect express expansion chassis, and initializing a peripheral component interconnect express device on the peripheral component interconnect express expansion chassis, where a bandwidth of each channel is not less than a sum of bandwidths of all peripheral component interconnect express slots in the peripheral component interconnect express expansion chassis;

detecting whether a current channel fails; and

if the current channel fails, disabling a peripheral component interconnect express interface of the current channel on a motherboard side, and switching to the remaining channels of a data link where the current channel is located for data transmission.

Optionally, the detecting whether a current channel fails includes:

when the operating system of the server starts, detecting whether there is an uncorrectable error in a current channel; and if there is the uncorrectable error, determining that the current channel fails; or

when the operating system of the server starts, detecting whether a quantity of correctable errors in a current channel reaches a first threshold; and if the quantity reaches the first threshold, determining that the current channel fails.

Optionally, the detecting whether a current channel fails includes:

during the operation of the peripheral component interconnect express device, continuously reading the register of the central processing unit; and if an uncorrectable error occurs in the register, determining that a current channel fails; or

during the operation of the peripheral component interconnect express device, continuously reading the register of the central processing unit; and if a quantity of correctable errors in the register reaches a second threshold, determining that a current channel fails.

Optionally, the method for controlling data transmission further includes:

generating fault information based on all currently faulty channels, and recording fault logs based on the fault information and channel switching information; and warning a link fault based on the fault information.

Optionally, the method for controlling data transmission further includes:

if all the channels of the data link fail in the fault information, determining that a device fault occurs; and

warning the device fault based on the fault information.

According to a fourth aspect of some embodiments of the present application, an apparatus for controlling data transmission is provided for implementing the method of controlling data transmission according to the third aspect of some embodiments of the present application, the apparatus including:

a management module, configured to, when a server starts, perform channel identification on each peripheral component interconnect express expansion chassis; if the peripheral component interconnect express expansion chassis has a plurality of channels, configure a default channel for the peripheral component interconnect express expansion chassis; and allocate corresponding peripheral component interconnect express resources to all the channels of each peripheral component interconnect express expansion chassis, and initialize a peripheral component interconnect express device on the peripheral component interconnect express expansion chassis, where a bandwidth of each channel is not less than a sum of bandwidths of all peripheral component interconnect express slots in the peripheral component interconnect express expansion chassis; and

a control module, configured to: detect whether a current channel fails; and if the current channel fails, disable a peripheral component interconnect express interface of the current channel on a motherboard side, and switch to the remaining channels of a data link where the current channel is located for data transmission.

According to a fifth aspect of some embodiments of the present application, a non-volatile readable storage medium is provided, having a computer program stored therein, the computer program, when executed by a processor, implementing the steps of the method for controlling data transmission according to the fourth aspect of some embodiments of the present application.

According to a sixth aspect of some embodiments of the present application, an electronic device is provided, including a memory, a processor, and a computer program stored in the memory and executable by the processor, the processor executing the computer program to implement the steps of the method for controlling data transmission according to the fourth aspect of some embodiments of the present application.

By using the peripheral component interconnect express expansion chassis provided in the present application, the switching unit integrates the downstream interface and the plurality of upstream interfaces, to achieve a data transmission architecture that a single-channel data link is updated to a multi-channel data link; by using multi-channel redundancy design, the data transmission channel might be automatically switched when a PCIe link error occurs, achieving stable resource transmission, and allowing for stable and normal service operation without shutdown; and compared with a conventional single transmission link, the stability and reliability of the PCIe link are significantly improved.

### BRIEF DESCRIPTION OF THE DRAWINGS

In order to illustrate technical solutions of some embodiments of the present application more clearly, the accompanying drawings required in the description of some embodiments of the present application will be briefly introduced below. Apparently, the drawings described below show merely some embodiments of the present application. For a person of ordinary skill in the art, other drawings might also be derived from these drawings without any creative efforts.

FIG. 1 is a schematic diagram of a peripheral component interconnect express (PCIe) expansion chassis according to some embodiments of the present application;

FIG. 2 is a schematic structural diagram of a PCIe link in a server according to some embodiments of the present application;

FIG. 3 is a schematic structural diagram of a PCIe link in a server according to some embodiments of the present application;

FIG. 4 is a flowchart of a method for controlling data transmission according to some embodiments of the present application;

FIG. 5 is a schematic diagram of an architecture of a switching unit according to some embodiments of the present application;

FIG. 6 is a work flowchart of a dual-channel PCIe link in some embodiments of the present application; and

FIG. 7 is a schematic diagram of an apparatus for controlling data transmission according to some embodiments of the present application.

### DETAILED DESCRIPTION

The following will provide a clear and complete description of the technical solutions in some embodiments of the present application with reference to the accompanying drawings. Apparently, the described embodiments are part of the embodiments of the present application, not all of them. Based on some embodiments of the present application, all other embodiments obtained by those of ordinary skill in the art without any creative efforts fall within the scope of protection of the present application.

It should be understood that “one embodiment” or “an embodiment” mentioned throughout the specification means that specific features, structures, or characteristics related to the embodiment are included in at least one embodiment of the present application. Therefore, “in one embodiment” or “in an embodiment” appearing throughout the specification does not necessarily refer to the same embodiment. In addition, these specific features, structures, or characteristics may be combined in one or more embodiments in any appropriate manner.

In some embodiments of the present application, it should be understood that the serial numbers of the following processes do not imply an order of execution. The order of execution of each process should be determined by its function and internal logic, and should not constitute any limitation on the implementation process of some embodiments of the present application.

Here, some exemplary embodiments will be described in detail, with examples shown in the accompanying drawings. When the following description refers to the accompanying drawings, the same reference numerals in different drawings represent the same or similar elements, unless otherwise indicated. The implementations described in the following exemplary embodiments do not represent all implementations consistent with the present application. On the contrary, the implementations are merely examples of an apparatus and a method that are consistent with some aspects of the present application described in detail in claims.

It should be noted that some embodiments and features in the embodiments of the present application may be combined with each other without conflict.

PCIe links in a server come from different Central Processing Unit (CPU) ports. Due to different CPU positions and different PCIe interface types and positions on a motherboard, a PCIe Margin value on each PCIe link is also different. Therefore, compatibility problems may occur when the PCIe links are matched with different PCIe expansion chassis or PCIe devices.

Existing PCIe errors are divided into two types: uncorrectable errors and correctable errors. The correctable errors may be corrected by hardware logics without software intervention, and their correction behaviors will not incur the loss of any information. The frequency of occurrence and quantity of such errors may be recorded by software.

The uncorrectable errors may affect the functionality of interfaces, and there is no clear mechanism in protocols to correct such errors. These errors often incur device speed reduction, bandwidth reduction, and even PCIe device loss. To repair such errors, the entire link and device need to be reset. The uncorrectable errors may be further divided into two types: fatal and non-fatal. The non-fatal uncorrectable errors may make specific transmission unreliable, but other functions of links and hardware are not affected. This is usually caused by an unreliable transaction layer but the links meet requirements. Device driver software provides a recovery mechanism and does not affect the operation of the links and other devices. The fatal uncorrectable errors are caused by unreliable links or hardware, and require resetting hardware devices on the links, involving device power outage and service interruption.

In related technologies, when UCEs or CEs on a PCIe link reach a threshold, fault repair is usually carried out by removing and replacing error report devices or restarting a device. For a PCIe device that supports hot plugging, when the PCIe device fails and the server is kept on, the system is notified by a hot-plug button to remove the PCIe device, the hot-plug service controls a device driver to disable the device and close the PCIe link and to power down the device, and a Basic Input Output System (BIOS) cancels resource configuration for a slot where the device is located. When the PCIe device is reinserted, management personnel may detect power through an in-place signal and notify a controller on an Operating System (OS) side to reopen the slot and allocate PCIe resources, and the system loads the driver to complete device initialization again.

However, this method might merely solve fault problems caused by devices. When the PCIe link fails, the replacement or initialization of the device cannot directly solve the problems, and system restart is required to try to solve the link problems. However, faulty physical links cannot be recovered even by timely system restart. Moreover, device replacement or link adjustment requires shutting down the device or disconnecting the power supply. Such a method has a serious impact on the normal operation of services. In this case, repeated debug verification and troubleshooting take a lot of time, seriously affecting the normal operation of services.

Therefore, the present application provides a multi-channel PCIe redundant link design, which combines firmware in a switching unit to automatically switch channels, whereby when a PCIe error occurs in a server, device resources are automatically switched to a redundant channel for transmission, to achieve the purpose of stable service data transmission without shutdown.

Hereinafter, the present application will be described in detail with reference to the accompanying drawings and in conjunction with some embodiments of the present application.

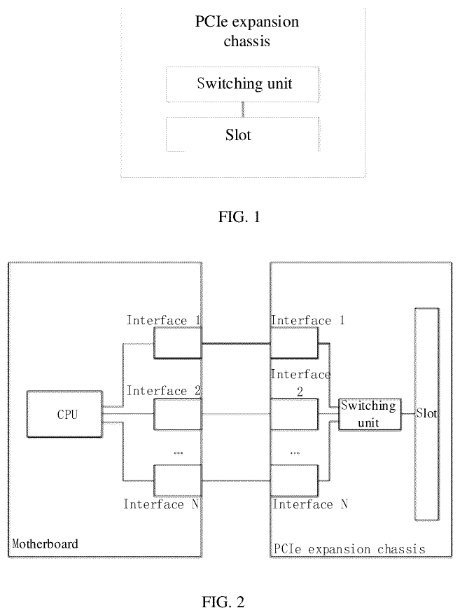

FIG. 1 is a schematic diagram of a PCIe expansion chassis according to some embodiments of the present application. As shown in FIG. 1, the PCIe expansion chassis includes a switching unit and at least one PCIe slot, the switching unit including one downstream interface and at least two upstream interfaces, where

the PCIe slot is used for installing a PCIe device;

the downstream interface is used for being connected to the PCIe slot;

the at least two upstream interfaces are used for being connected to a CPU on a motherboard side, to form a multi-channel data link; and

during data transmission, the switching unit selects any channel in the multi-channel data link for data transmission.

In some embodiments of the present application, a multi-channel data link hardware architecture is employed to achieve redundant backup of a service transmission link, so as to improve the stability and reliability of service operation. In the PCIe bus architecture, the PCIe expansion chassis (usually referred to as a riser) serves as an important part of the link, used for connecting data communication between a bottom plate and a top plate.

The PCIe expansion chassis of the present application includes one switching unit and at least one PCIe slot. The PCIe slot is used for installing the PCIe device. The switching unit includes one downstream interface and a plurality of upstream interfaces, and is connected to the PCIe slot through the downlink interface and connected to the PCIe device; and the switching unit is connected to PCIe interfaces on the motherboard side through the plurality of upstream interfaces to enable communication between the PCIe device in the PCIe slot and the CPU. Through the upstream interfaces and downstream interface of the switching unit, the multi-channel data link is formed between the PCIe device and the CPU. During operation of the device, data transmission is carried out through one channel of the multi-channel data link. If the current data channel fails, the switching unit might automatically switch to any of the remaining redundant channels for data transmission, ensuring the stability and reliability of services.

As some implementations of the present application, a bandwidth of the downstream interface in the switching unit is a sum of bandwidths of all the PCIe slots; and

a bandwidth of any upstream interface in the switching unit is not less than the bandwidth of the downstream interface.

In practical applications, the commonly used PCIe slots based on bandwidth requirements include X2, X4, X8, X16, and other specifications. Different slots might support PCIe devices with different bandwidth rates. For example, one PCIe 3.0 X8 slot might support a network card with the same rate (such as X710). In order to meet various configuration requirements, a motherboard of a server usually provides a plurality of PCIe interfaces. By matching the PCIe interfaces with different PCIe expansion chassis, a user might insert various external PCIe cards to support different configurations. A conventional PCIe expansion chassis architecture includes an upstream interface and a downstream interface with consistent upstream bandwidth and downstream bandwidth, and a bandwidth ratio of the downstream interface to a slot is 1:1 or 1:2. For example, if the upstream bandwidth corresponds to X16 bandwidth resources, the slot may be either 1 X16 slot or 2 X8 slots. In some embodiments of the present application, the bandwidth ratio of the upstream interface to the downstream interface in the multi-channel data link is N:1 (N is not less than 2). In order to ensure that the bandwidth of the upstream interface might support the normal operation of the PCIe device, the bandwidths of all the upstream interfaces in the multi-channel data link are set to be not less than the bandwidth of the downstream interface, to meet the bandwidth requirements of PCIe devices of different specifications supported by the slots. For example, if the bandwidth of the downstream interface supports an X8 PCIe device, the bandwidth of each upstream interface is not less than X8 to ensure that the PCIe device will not experience bandwidth reduction when switching channels for service data transmission, ensuring stable operation of the device.

As some implementations of the present application, bandwidths of all the upstream interfaces in the switching unit are equal.

In some embodiments, in order to ensure the operational stability of the PCIe device and save bandwidth resources of the CPU, when the bandwidth resources are allocated for the multi-channel data link, equal bandwidth resources are allocated to each upstream interface, keeping the bandwidth rate of service data transmission stable before and after switching channels.

As some implementations of the present application, the PCIe slot is one X16 slot, or two X8 slots; and

the switching unit includes one downstream interface and two upstream interfaces, where a bandwidth of each upstream interface is equal to that of the downstream interface; and the bandwidth of the downstream interface is a sum of bandwidths of all the PCIe slots.

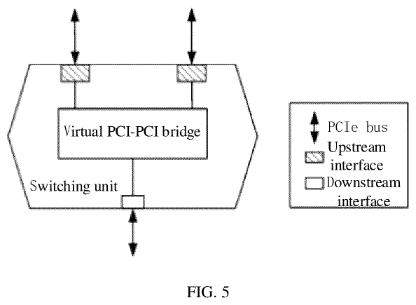

FIG. 5 is a schematic architecture diagram of a switching unit according to some embodiments of the present application. As shown in FIG. 5, the switching unit might construct a dual-channel data link architecture, including two upstream interfaces and one downstream interface, connected through virtual PCI-PCI bridge technology. The virtual PCI-PCI bridge is a virtual bridging technology that enables conversion between PCI Express (PCIe) and PCI buses within a computer. This technology allows different devices within the computer to communicate with each other by sharing a memory space, thereby achieving more efficient resource utilization and data transmission. In some embodiments of the present application, the upstream interfaces and the downstream interface of the switching unit are connected to the CPU and the PCIe device through a PCIe bus respectively, to form a dual-channel data link. During initialization of the server, the BIOS loads corresponding firmware for the switching unit, enabling the switching unit to have a function of automatically switching channels in the multi-channel data link. During service data transmission, the switching unit selects one of the channels for data transmission. When the current transmission channel fails, the switching unit might automatically identify the faulty channel and switch the faulty channel to a redundant channel to continue the service data transmission, thereby ensuring the stability of service operation.

In some embodiments of the present application, the dual-channel data link is constructed by the switching unit to achieve maximum compatibility with PCIe resources of X16 devices. By adding a redundant data transmission channel, the stability of service operation is improved, and the influence of PCIe link faults on user usage scenarios is reduced.

Based on the same inventive concept, some embodiments of the present application provide a server, including:

at least one PCIe expansion chassis, which is the PCIe expansion chassis in any of the foregoing embodiments and is a multi-channel PCIe expansion chassis; and

a CPU, connected to the upstream interfaces of each PCIe expansion chassis through a plurality of PCIe interfaces on a motherboard side, configured to conduct data communication with the PCIe device on the PCIe expansion chassis, and configured to, when any channel in the multi-channel data link fails, disable the PCIe interface of the channel on the motherboard side.

In some embodiments of the present application, the server includes the CPU and a plurality of multi-channel PCIe expansion chassis, where each PCIe expansion chassis is connected to the PCIe interface on the motherboard side through the upstream interface of the switching unit of the PCIe expansion chassis. FIG. 2 is a schematic structural diagram of a PCIe link in a server according to some embodiments of the present application. As shown in FIG. 2, taking an N-channel PCIe expansion chassis as an example, the upstream interfaces of the PCIe expansion chassis (interface 1, interface 2. interface N on the PCIe expansion chassis in FIG. 2) are connected to the PCIe interfaces on the motherboard (interface 1, interface 2 . . . interface N on the motherboard in FIG. 2) through PCIe cables, to form a multi-channel data link between the PCIe devices in the slots and the CPU. In some embodiments of the present application, the PCIe expansion chassis may be provided with a plurality of upstream interfaces, to form a multi-channel data link between the CPU and the PCIe devices. The more channels in the data link that serve as backup redundancy, the higher the stability and reliability of the link. When any channel that transmits data fails, the switching unit automatically switches to a redundant channel to continue providing service data support, thereby avoiding poor user experience caused by service interruption.

When a data transmission channel is switched, a CPU port on the motherboard side is disabled to disable the current data transmission channel. The switching unit determines and executes channel switching based on disable information about the CPU port. For a faulty data transmission channel, management personnel might conduct troubleshooting and repair during leisure time. This solution also reduces the urgency of fault repair in the PCIe link. The management personnel might arrange troubleshooting time reasonably, making the operation and maintenance of the server more flexible.

As some implementations of the present application, a BIOS runs on the CPU; and the BIOS is configured to perform the following steps: when the server starts, the BIOS allocates corresponding PCIe resources to at least one channel in each multi-channel data link, where the bandwidth of each channel is not less than the sum of the bandwidths of all the PCIe slots in the PCIe expansion chassis.

In some embodiments of the present application, the BIOS performs resource allocation on the multi-channel data link. When the server starts, the BIOS allocates PCIe resources to at least one channel in the multi-channel data link. The PCIe resources mainly include bus number, PCIe bus bandwidth, memory space, I/O space, and the like. The bandwidth allocated to each channel needs to be able to support the maximum bandwidth compatible with the slots on the PCIe expansion chassis. For example, if the slot on the PCIe expansion chassis is 1 X16 slot, the bandwidth allocated to any channel in the multi-channel data link of the PCIe expansion chassis cannot be less than the bandwidth corresponding to the X16 slot, to ensure that the PCIe device interrupted in the slot might operate normally in any channel. Only after a channel is allocated PCIe resources, might the channel be selected by the switching unit during device operation. In some embodiments of the present application, the multi-channel data link is compatible with conventional single-channel data link configurations. When PCIe resources are configured to support only one channel in the data link, the data link serves as a single-channel data link to transmit service data.

In some embodiments of the present application, when PCIe resources are allocated for the multi-channel data link, corresponding PCIe resources may be allocated to some channels in the data link according to actual needs, whereby the allocation of CPU resources might be flexibly controlled while providing backup channels for service data transmission, to adapt to different reliability levels of different services, to achieve the purposes of balancing CPU resource occupancy and ensuring service operation reliability.

As some implementations of the present application, the server further includes:

a baseboard management controller, configured to: when the server starts, perform channel identification on each PCIe expansion chassis; and if the PCIe expansion chassis has a plurality of channels, configure a default channel for the PCIe expansion chassis;

where the switching unit is further configured to preferentially select the default channel for data transmission; and
the BIOS is further configured to allocate corresponding PCIe resources to all the channels of each PCIe expansion chassis.

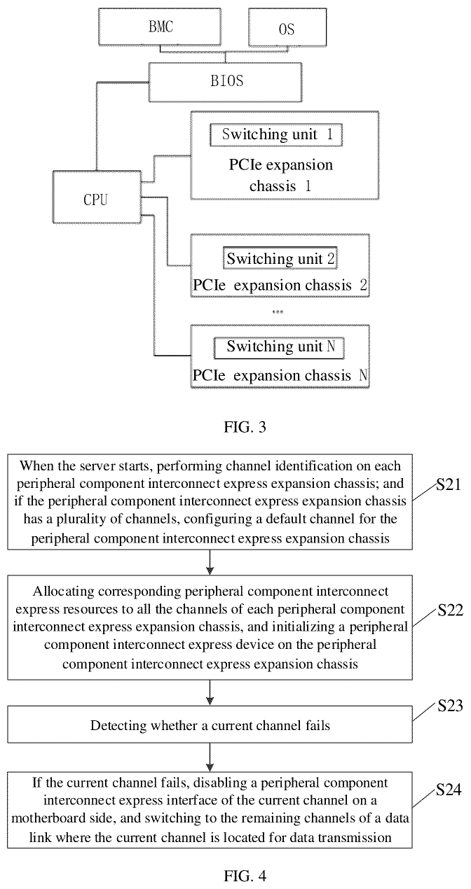

In some embodiments of the present application, the server further includes a Baseboard Management Controller (BMC). FIG. 3 is a schematic structural diagram of a PCIe link in a server according to some embodiments of the present application. As shown in FIG. 3, the BMC first identifies the PCIe expansion chassis through the BIOS when the server starts. If it is identified that the PCIe expansion chassis supports a multi-channel data link, the BMC provides a link channel configuration function to management personnel, and the management personnel designate one channel in the multi-channel data link of the PCIe expansion chassis as a default channel through the BMC. During the operation of the server, the switching unit preferentially selects the default channel for service data transmission.

In some embodiments of the present application, when it is identified that the PCIe expansion chassis supports the multi-channel data link, the BIOS allocates corresponding PCIe resources to each channel, so as to fully utilize redundant channels of the data link and provide stable data transmission guarantee for application scenarios with high service reliability requirements.

As some implementations of the present application, the baseboard management controller is configured to: when the server starts, determine whether the PCIe expansion chassis has a plurality of channels by identifying an underlying unit Field Replaceable Unit (FRU) of the PCIe expansion chassis; and after the configuration of the default channel is completed, store information of the default channel in an Erasable Programmable Read-Only Memory (EPROM).

In some embodiments of the present application, the BMC identifies whether the PCIe expansion chassis supports a multi-channel data link by identifying the FRU of the PCIe expansion chassis through the BIOS. If the PCIe expansion chassis has a plurality of channels, the BMC provides a link channel configuration function to the management personnel. After the management personnel configures the default channel, the BMC stores configuration information in the EPROM to prevent the loss of the configuration information.

As some implementations of the present application, the BIOS is further configured to perform the following steps when an operating system of the sever starts:

detecting whether there is an uncorrectable error in the current channel; if there is the uncorrectable error, determining that the current channel fails; or detecting whether a quantity of correctable errors in the current channel reaches a first threshold; if the quantity reaches the first threshold, determining that the current channel fails; and

when it is determined that the current channel fails, disabling the PCIe interface of the current channel on the motherboard side;

where the switching unit is further configured to switch, based on disable information about the PCIe interface on the motherboard side, to the remaining channels of the data link where the current channel is located for data transmission.

In some embodiments of the present application, when the server starts, the BIOS performs fault detection and link switching control on the multi-channel data link.

When the server starts, the BIOS performs fault detection to determine whether there is a UCE in the current default data transmission channel. When there is the UCE, the BIOS determines that the channel fails and needs to be switched to a redundant channel for data transmission, thereby ensuring normal service operation. The BIOS disables the PCIe interface of the current channel on the motherboard side. Upon receiving the disable information about the CPU port, the switching unit automatically switches to a redundant channel to transmit service data.

Optionally, if the BIOS does not detect any UCE, but the quantity of CEs in the current channel reaches the first threshold, that is, the quantity of correctable errors in the current data transmission channel reaches a threshold for switching channels, the reliability of the current channel is relatively low, and it is determined that the current channel fails and needs to be switched to a redundant channel to run services. The BIOS disables the PCIe interface of the current channel on the motherboard side. Upon receiving the disable information about the CPU port, the switching unit automatically switches to a redundant channel to transmit service data. The first threshold may be set to 1000. In practical applications, the first threshold may be flexibly configured, and the present application does not limit it.

As some implementations of the present application, the BIOS is further configured to perform the following steps during the operation of the PCIe device:

continuously reading the register of the CPU, and if an uncorrectable error occurs in the register, determining that the current channel fails; or continuously reading the register of the CPU, and if a quantity of correctable errors in the register reaches a second threshold, determining that the current channel fails; and

when it is determined that the current channel fails, disabling the PCIe interface of the current channel on the motherboard side;

where the switching unit is further configured to switch, based on disable information about the PCIe interface on the motherboard side, to the remaining channels of the data link where the current channel is located for data transmission.

In some embodiments of the present application, during the operation of the PCIe device, periodic and continuous fault detection is performed on the multi-channel data link through the BIOS, and redundant link switching is controlled when a fault occurs.

During the operation of the device, the BIOS continuously reads the register of the CPU to determine whether a UCE occurs in the register, and determines that the channel fails when the UCE occurs. At this time, the BIOS disables the PCIe interface of the current channel on the motherboard side. Upon receiving the disable information about the CPU port, the switching unit automatically switches to a redundant channel for data transmission to ensure normal service operation.

Optionally, if the BIOS does not detect any UCE in the register, but reads that the quantity of CEs reaches the second threshold, that is, the quantity of correctable errors in the current data transmission channel reaches a threshold for switching channels, the reliability of the current channel is relatively low, it is determined that the current channel fails, and the CPU port of the current channel on the motherboard side is disabled. Upon receiving the disable information about the CPU port, the switching unit automatically switches to a redundant channel to ensure normal service operation. In some embodiments of the present application, the second threshold may be flexibly configured according to the actual situation of the link, and the present application does not limit this.

As some implementations of the present application, the BIOS is further configured to generate fault information based on all currently faulty channels, and send the fault information and channel switching information to the operating system of the server and a baseboard management controller;

the operating system of the server records fault logs based on the received fault information and channel switching information; and

the baseboard management controller records fault logs based on the received fault information and channel switching information.

In some embodiments of the present application, the BIOS performs fault monitoring on the multi-channel data link. In some embodiments of the present application, upon detecting that a UCE occurs or a quantity of CEs reaches a set threshold in the current data transmission channel, the BIOS determines that the data link where the current channel is located fails. At this time, the fault information of the current channel and the channel switching information are sent to the OS and the BMC respectively, and the OS and the BMC record fault logs respectively, making it convenient for management personnel to view historical faults of the device at any time.

As some implementations of the present application, the baseboard management controller warns a link fault based on the received fault information.

In some embodiments of the present application, the BMC generates a link fault alarm prompt based on the received channel fault information and channel switching information, and provides the prompt on a management interface for management personnel to know the current operating status of the PCIe data link, quickly and accurately locate the faulty link, and make a corresponding fault repair plan.

As some implementations of the present application, the baseboard management controller is further configured to, when all the channels of the data link fail in the received fault information, determine that a device fault occurs, and warn a device fault.

In some embodiments of the present application, if all the channels in the data link connected to the PCIe device fail, it may be determined that the fault is most likely caused by the PCIe device. At this time, the BMC determines that a PCIe device fault occurs, generates an alarm prompt for the device fault, and provides the prompt on the management interface for management personnel to quickly locate the faulty device and replace the faulty device in a timely manner, thereby reducing the duration of service interruption and avoiding a significant impact on user service.

Based on the same inventive concept, some embodiments of the present application provide a method for controlling data transmission. The method is applied to the server in some embodiments above. FIG. 4 is a flowchart of a method for controlling data transmission according to some embodiments of the present application. As shown in FIG. 4, the method includes:

S21: when the server starts, performing channel identification on each peripheral component interconnect express (PCIe) expansion chassis; and if the peripheral component interconnect express expansion chassis has a plurality of channels, configuring a default channel for the peripheral component interconnect express expansion chassis;

S22: allocating corresponding peripheral component interconnect express resources to all the channels of each peripheral component interconnect express expansion chassis, and initializing a peripheral component interconnect express device on the peripheral component interconnect express expansion chassis, where a bandwidth of each channel is not less than a sum of bandwidths of all peripheral component interconnect express slots in the peripheral component interconnect express expansion chassis;

S23: detecting whether the current channel fails; and

S24: if the current channel fails, disabling a peripheral component interconnect express interface of the current channel on a motherboard side, and switching to the remaining channels of a data link where the current channel is located for data transmission.

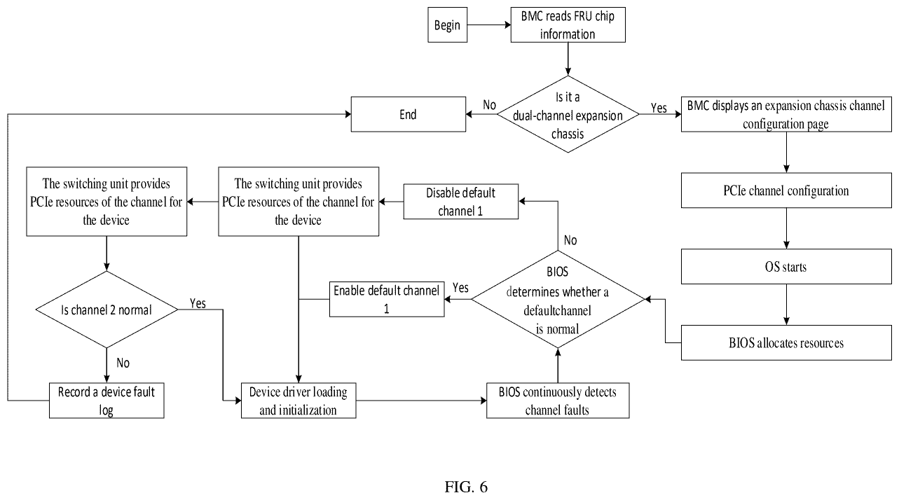

FIG. 6 is a work flowchart of a dual-channel PCIe link in some embodiments of the present application. As shown in FIG. 6, a dual-channel data link is taken as an example for explanation. In some embodiments of the present application, a dual-channel data link is used to transmit service data, and fault detection and monitoring steps are as follows:
(1) Firstly, firmware is configured to support the switching unit in the PCIe expansion chassis, enabling the switching unit to perform automatic channel switching.
(2) The BMC identifies the PCIe expansion chassis through an underlying unit FRU of the PCIe expansion chassis. If the PCIe expansion chassis is a single-channel expansion chassis, conventional configuration is performed. If the BMC identifies that the PCIe expansion chassis is a dual-channel PCIe expansion chassis, the BMC provides a link channel configuration interface, and management personnel might configure a default channel through the BMC. For example, channel 1 is set as the default channel, and channel 2 serves as a redundant channel. The BMC stores channel setting information in an EPROM.
(3) When the server starts, the BIOS allocates resources to the two PCIe channels of the PCIe expansion chassis, and the switching unit preferentially provides resources to the PCIe device based on the default channel 1 configured by the BMC. In this phase, the device completes driver loading and initialization.
(4) When the OS starts, the BIOS detects whether the default channel 1 is normal. If channel 1 is normal, channel 1 will be selected for data transmission during device operation. When a UCE occurs or a quantity of CEs exceeds a threshold in the default channel 1, the BIOS disables the CPU port of the default channel. At this time, the PCIe resources in the upstream channel 1 are cut off due to the disabling of the CPU port. At this time, as the remaining channel 2 in the data link might continue to provide resources, the switching unit of the PCIe expansion chassis automatically switches the PCIe resources to channel 2, ensuring that resources continue to be provided to the PCIe device and ensuring stable device operation. At this time, the BMC records a fault log about the default channel 1 for operators to remotely view the device operation status.

When the PCIe device is working, the BIOS continuously reads register information of the CPU. If it is read that the UCE occurs or the quantity of CEs exceeds the threshold in the default channel 1, the BIOS disables the CPU port of channel 1, and the switching unit automatically switches the PCIe resources to channel 2. In addition, the BIOS reports the current channel fault to the BMC, and the BMC records a channel switching log and a fault log about channel 1.
(5) When the link is switched to channel 2, channel 2 is detected. If it is also detected in channel 2 that a UCE occurs or a quantity of CEs exceeds the threshold, the fault is mostly likely a PCIe device fault. The BMC records a device fault log and may give a device fault alarm as needed.

As some implementations of the present application, the detecting whether the current channel fails includes:

when the operating system of the server starts, detecting whether there is an uncorrectable error in the current channel; and if there is the uncorrectable error, determining that the current channel fails; or

when the operating system of the server starts, detecting whether a quantity of correctable errors in the current channel reaches a first threshold; and if the quantity reaches the first threshold, determining that the current channel fails.

As some implementations of the present application, the detecting whether the current channel fails includes:

during the operation of the PCIe device, continuously reading the register of the CPU, and if an uncorrectable error occurs in the register, determining that the current channel fails; or

during the operation of the PCIe device, continuously reading the register of the CPU, and if a quantity of correctable errors in the register reaches a second threshold, determining that the current channel fails.

As some implementations of the present application, the method for controlling data transmission further includes:

generating fault information based on all currently faulty channels, and recording fault logs based on the fault information and channel switching information; and

warning a link fault based on the fault information.

As some implementations of the present application, the method for controlling data transmission further includes:

if all the channels of the data link fail in the fault information, determining that a device fault occurs; and

warning the device fault based on the fault information.

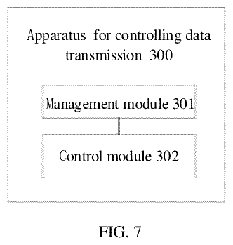

Based on the same inventive concept, some embodiments of the present application provide an apparatus for controlling data transmission. Refer to FIG. 7. FIG. 7 is a schematic diagram of an apparatus 300 for controlling data transmission according to some embodiments of the present application. As shown in FIG. 7, the apparatus includes:

a management module 301, configured to: when a server starts, perform channel identification on each PCIe expansion chassis; if the PCIe expansion chassis has a plurality of channels, configure a default channel for the PCIe expansion chassis; and allocate corresponding PCIe resources to all the channels of each PCIe expansion chassis, and initialize a PCIe device on the PCIe expansion chassis, where a bandwidth of each channel is not less than a sum of bandwidths of all PCIe slots in the PCIe expansion chassis; and

a control module 302, configured to: detect whether the current channel fails; and if the current channel fails, disable a PCIe interface of the current channel on a motherboard side, and switch to the remaining channels of a data link where the current channel is located for data transmission.

As some implementations of the present application, the control module 302 is configured to perform the following steps:

when the operating system of the server starts, detecting whether there is an uncorrectable error in the current channel; and if there is the uncorrectable error, determining that the current channel fails; or

when the operating system of the server starts, detecting whether a quantity of correctable errors in the current channel reaches a first threshold; and if the quantity reaches the first threshold, determining that the current channel fails.

As some implementations of the present application, the control module 302 is further configured to perform the following steps:

during the operation of the PCIe device, continuously reading the register of the CPU, and if an uncorrectable error occurs in the register, determining that the current channel fails; or

during the operation of the PCIe device, continuously reading the register of the CPU, and if a quantity of correctable errors in the register reaches a second threshold, determining that the current channel fails.

As some implementations of the present application, the apparatus 300 for controlling data transmission further includes a monitoring module, configured to perform the following steps:

generating fault information based on all currently faulty channels, and recording fault logs based on the fault information and channel switching information; and warning a link fault based on the fault information.

As some implementations of the present application, the monitoring module is further configured to perform the following steps:

if all the channels of the data link fail in the fault information, determining that a device fault occurs; and

warning the device fault based on the fault information.

Based on the same inventive concept, some embodiments of the present application provide a non-volatile readable storage medium, having a computer program stored therein, the program, when executed by a processor, implementing the steps of the method for controlling data transmission as in some embodiments of the present application.

Based on the same inventive concept, some embodiments of the present application provide an electronic device, the electronic device including a memory, a processor, and a computer program stored in the memory and executable by the processor, and the processor executing the computer program to implement the steps of the method for controlling data transmission as in some embodiments of the present application.

Regarding the apparatus in some embodiments above, the specific operation of each module therein is described in detail in some embodiments of the method, and will not be elaborated here.

The above are merely some preferred embodiments of the present application and are not intended to limit the present application. Any modifications, equivalent substitutions, improvements, and the like made within the spirit and principles of the present application fall within the scope of protection of the present application.

For some method embodiments, for the sake of simplicity, they are described as a series of action combinations. However, a person skilled in the art should be aware that the present application is not limited by the order of the described actions, as some steps may be performed in other orders or simultaneously according to the present application. Secondly, the person skilled in the art should also be aware that some embodiments described in the specification are preferred embodiments, and the involved actions and components are not necessary for the present application.

The person skilled in the art should understand that some embodiments of the present application may be provided as methods, apparatuses, or computer program products. Therefore, some embodiments of the present application may be in a form of fully hardware embodiments, fully software embodiments, or embodiments combining software and hardware aspects. Moreover, some embodiments of the present application may be in a form of a computer program product implemented on one or more non-volatile readable storage media including computer available program code (including but not limited to a disk memory, a Compact Disc Read-Only Memory (CD-ROM), an optical memory, and the like).

Some embodiments of the present application are described with reference to the flowcharts and/or block diagrams of the methods, terminal devices (systems), and computer program products according to some embodiments of the present application. It should be understood that computer program instructions may be used to implement each process and/or block in the flowcharts and/or block diagrams, or a combination of processes and/or blocks in the flowcharts and/or block diagrams. The computer program instructions may be provided to a general-purpose computer, a dedicated computer, an embedded processor, or a processor of any other programmable data processing terminal device to generate a machine, whereby the instructions executed by a computer or a processor of any other programmable data processing terminal device generate an apparatus for implementing a specific function in one or more processes in the flowcharts and/or in one or more blocks in the block diagrams.

The computer program instructions may be stored in a computer-readable memory that might instruct the computer or any other programmable data processing terminal device to work in a specific manner, whereby the instructions stored in the computer-readable memory generate an artifact that includes an instruction apparatus. The instruction apparatus implements a specific function in one or more processes in the flowcharts and/or in one or more blocks in the block diagrams.

The computer program instructions may be loaded onto a computer or other programmable data processing terminal device, and a series of operations and steps are performed on the computer or the other programmable terminal device, thereby generating computer-implemented processing. Accordingly, instructions executed on the computer or the other programmable terminal device provide steps for implementing a specific function in one or more processes in the flowcharts and/or in one or more blocks in the block diagrams.

Although some preferred embodiments of the present application are described, those skilled in the art may make additional alterations and modifications to these embodiments once they learn the basic inventive concept. Therefore, the appended claims are intended to be interpreted as including preferred embodiments and all alterations and modifications falling within the scope of some embodiments of the present application.

Finally, it should be noted that in the specification, relational terms such as first and second are used only to differentiate an entity or operation from another entity or operation, and do not necessarily require or imply that any actual relationship or sequence exists between these entities or operations. Moreover, the terms “include”, “comprise”, or any other variants thereof are intended to cover a non-exclusive inclusion, whereby a process, method, article, or terminal device that includes a series of elements not only includes those elements, but further includes other elements that are not expressly listed, or further includes elements inherent to such a process, method, article, or terminal device. Without further limitations, an element limited by the statement “including a/an.” does not exclude the existence of other identical elements in the process, method, article, or terminal device that includes the element.

The above provides a detailed introduction to the PCIe expansion chassis, the server, the method and apparatus for controlling data transmission, and the product provided by the present application. Specific examples are applied herein to explain the principles and implementations of the present application. The descriptions of the above embodiments are merely used to help understand the method and core idea of the present application. Meanwhile, for general technical personnel in the art, there may be alterations in the specific implementations and application scope based on the ideas of the present application. Therefore, the content of this specification should not be understood as limiting the present application.

1. A server, comprising:
at least one peripheral component interconnect express expansion chassis, the peripheral component interconnect express expansion chassis being a multi-channel peripheral component interconnect express expansion chassis; the peripheral component interconnect express expansion chassis comprising a switching unit and at least one peripheral component interconnect express slot, and the switching unit comprising one downstream interface and at least two upstream interfaces, wherein the peripheral component interconnect express slot is used for installing a peripheral component interconnect express device; the downstream interface is used for being connected to the peripheral component interconnect express slot; the at least two upstream interfaces are used for being connected to a central processing unit on a motherboard side, to form a multi-channel data link between the central processing unit and any peripheral component interconnect express slot; the being connected to a central processing unit on a motherboard side comprises: the at least two upstream interfaces are in one-to-one connection with interfaces of a corresponding quantity on the motherboard side; during data transmission, the switching unit selects any channel in the multi-channel data link for data transmission; if a current data channel fails, the current data channel is automatically switched to any of remaining redundant channels for data transmission; and
the central processing unit, connected to the upstream interfaces of each peripheral component interconnect express expansion chassis through a plurality of peripheral component interconnect express interfaces on the motherboard side respectively, configured to conduct data communication with the peripheral component interconnect express device on the peripheral component interconnect express expansion chassis, and configured to, when any channel in the multi-channel data link fails, disable the peripheral component interconnect express interface of the channel on the motherboard side.

2. The server according to claim 1, wherein a bandwidth of the downstream interface in the switching unit is a sum of bandwidths of all the peripheral component interconnect express slots; and
a bandwidth of any of the at least two upstream interfaces in the switching unit is not less than the bandwidth of the downstream interface.

3. The server according to claim 1, wherein bandwidths of all of the at least two upstream interfaces in the switching unit are equal.

4. The server according to claim 1, wherein the peripheral component interconnect express slot is one X16 slot or two X8 slots; and
the at least two upstream interfaces is two upstream interfaces, wherein a bandwidth of each of the two upstream interfaces is equal to a bandwidth of the downstream interface; and the bandwidth of the downstream interface is a sum of bandwidths of all the peripheral component interconnect express slots.

5. The server according to claim 1, wherein a basic input output system runs on the central processing unit; and the basic input output system is configured to perform the following step: when the server starts, the basic input output system allocates corresponding peripheral component interconnect express resources to at least one channel in each multi-channel data link, wherein a bandwidth of each channel is not less than a sum of bandwidths of all the peripheral component interconnect express slots in the peripheral component interconnect express expansion chassis.

6. The server according to claim 5, further comprising:
a baseboard management controller, configured to: when the server starts, perform channel identification on each peripheral component interconnect express expansion chassis; and when the peripheral component interconnect express expansion chassis has a plurality of channels, configure a default channel for the peripheral component interconnect express expansion chassis;
wherein the switching unit is further configured to select the default channel for data transmission; and
the basic input output system is further configured to allocate the corresponding peripheral component interconnect express resources to all of the plurality of channels of the peripheral component interconnect express expansion chassis.

7. The server according to claim 6, wherein the baseboard management controller is configured to: when the server starts, determine whether the peripheral component interconnect express expansion chassis has the plurality of channels by identifying an underlying unit Field Replaceable Unit (FRU) of the peripheral component interconnect express expansion chassis; and after a configuration of the default channel is completed, store information of the default channel in an erasable programmable read-only memory.

8. The server according to claim 5, wherein the basic input output system is further configured to perform the following steps when an operating system of the server starts:
detecting whether there is an uncorrectable error in a current channel; when there is the uncorrectable error, determining that the current channel fails; or detecting whether a quantity of correctable errors in the current channel reaches a first threshold; when the quantity reaches the first threshold, determining that the current channel fails; and
when it is determined that the current channel fails, disabling the peripheral component interconnect express interface of the current channel on the motherboard side; and
wherein the switching unit is further configured to switch, based on disable information about the peripheral component interconnect express interface on the motherboard side, to the remaining redundant channels of the multi-channel data link where the current channel is located for data transmission.

9. The server according to claim 5, wherein the basic input output system is further configured to perform the following steps during operation of the peripheral component interconnect express device:
continuously reading a register of the central processing unit, and when an uncorrectable error occurs in the register, determining that a current channel fails; or continuously reading the register of the central processing unit, and when a quantity of correctable errors in the register reaches a second threshold, determining that the current channel fails; and
when it is determined that the current channel fails, disabling the peripheral component interconnect express interface of the current channel on the motherboard side; and
wherein the switching unit is further configured to switch, based on disable information about the peripheral component interconnect express interface on the motherboard side, to the remaining redundant channels of the data link where the current channel is located for data transmission.

10. The server according to claim 8, wherein the basic input output system is further configured to generate fault information based on all currently faulty channels, and send the fault information and channel switching information to the operating system of the server and a baseboard management controller;
the operating system of the server records fault logs based on the fault information and the channel switching information; and
the baseboard management controller records the fault logs based on the fault information and the channel switching information.

11. The server according to claim 10, wherein the baseboard management controller warns of a link fault based on the fault information.

12. The server according to claim 10, wherein the baseboard management controller is further configured to, if all of the plurality of channels of the data link fail in the fault information, determine that a device fault occurs, and warn of the device fault.

13. A method for controlling data transmission, being applied to a server, and comprising:
when the server starts, performing channel identification on each peripheral component interconnect express expansion chassis; if the peripheral component interconnect express expansion chassis has a plurality of channels, configuring a default channel for the peripheral component interconnect express expansion chassis;
allocating corresponding peripheral component interconnect express resources to all the channels of the peripheral component interconnect express expansion chassis, and initializing a peripheral component interconnect express device on the peripheral component interconnect express expansion chassis, wherein a bandwidth of each channel is not less than a sum of bandwidths of all peripheral component interconnect express slots in the peripheral component interconnect express expansion chassis;
detecting whether a current channel fails; and
if the current channel fails, disabling a peripheral component interconnect express interface of the current channel on a motherboard side, and switching to remaining redundant channels of a data link where the current channel is located for data transmission;
wherein the server comprises:
at least one peripheral component interconnect express expansion chassis, the peripheral component interconnect express expansion chassis being a multi-channel peripheral component interconnect express expansion chassis; the peripheral component interconnect express expansion chassis comprising a switching unit and at least one peripheral component interconnect express slot, and the switching unit comprising one downstream interface and at least two upstream interfaces, wherein the peripheral component interconnect express slot is used for installing the peripheral component interconnect express device; the downstream interface is used for being connected to the peripheral component interconnect express slot; the at least two upstream interfaces are used for being connected to a central processing unit on the motherboard side, to form a multi-channel data link between the central processing unit and any peripheral component interconnect express slot; the being connected to a central processing unit on a motherboard side comprises: the at least two upstream interfaces are in one-to-one connection with interfaces of a corresponding quantity on the motherboard side; during data transmission, the switching unit selects any channel in the multi-channel data link for data transmission; if a current data channel fails, the current data channel is automatically switched to any of the remaining redundant channels for data transmission; and
the central processing unit, connected to the upstream interfaces of each peripheral component interconnect express expansion chassis through a plurality of peripheral component interconnect express interfaces on the motherboard side respectively, configured to conduct data communication with the peripheral component interconnect express device on the peripheral component interconnect express expansion chassis, and configured to, when any channel in the multi-channel data link fails, disable the peripheral component interconnect express interface of the channel on the motherboard side.

14. The method for controlling data transmission according to claim 13, wherein the detecting whether a current channel fails comprises:
when an operating system of the server starts, detecting whether there is an uncorrectable error in the current channel; and when if there is the uncorrectable error, determining that the current channel fails; or
when the operating system of the server starts, detecting whether a quantity of correctable errors in the current channel reaches a first threshold; and when the quantity reaches the first threshold, determining that the current channel fails.

15. The method for controlling data transmission according to claim 13, wherein the detecting whether a current channel fails comprises:
during operation of the peripheral component interconnect express device, continuously reading a register of the central processing unit; and when an uncorrectable error occurs in the register, determining that the current channel fails; or
during the operation of the peripheral component interconnect express device, continuously reading the register of the central processing unit; and when a quantity of correctable errors in the register reaches a second threshold, determining that the current channel fails.

16. The method for controlling data transmission according to claim 14, further comprises:
generating fault information based on all currently faulty channels, and recording fault logs based on the fault information and channel switching information; and
warning of a link fault based on the fault information.

17. The method for controlling data transmission according to claim 16, further comprises:
if all the channels of the data link fail in the fault information, determining that a device fault occurs; and
warning of the device fault based on the fault information.

18. (canceled)

19. A non-volatile readable storage medium, having a computer program stored therein, wherein the computer program, when executed by a processor, implements the method according to claim 13.

20. An electronic device, comprising a storage device, a processor, and a computer program stored in the storage device and executable by the processor, wherein the processor executes the computer program to implement a method for controlling data transmission, being applied to a server, and comprises:
when the server starts, performing channel identification on each peripheral component interconnect express expansion chassis; if the peripheral component interconnect express expansion chassis has a plurality of channels, configuring a default channel for the peripheral component interconnect express expansion chassis;
allocating corresponding peripheral component interconnect express resources to all the channels of the peripheral component interconnect express expansion chassis, and initializing a peripheral component interconnect express device on the peripheral component interconnect express expansion chassis, wherein a bandwidth of each channel is not less than a sum of bandwidths of all peripheral component interconnect express slots in the peripheral component interconnect express expansion chassis;
detecting whether a current channel fails; and
if the current channel fails, disabling a peripheral component interconnect express interface of the current channel on a motherboard side, and switching to remaining redundant channels of a data link where the current channel is located for data transmission;
wherein the server comprises:
at least one peripheral component interconnect express expansion chassis, the peripheral component interconnect express expansion chassis being a multi-channel peripheral component interconnect express expansion chassis; the peripheral component interconnect express expansion chassis comprising a switching unit and at least one peripheral component interconnect express slot, and the switching unit comprising one downstream interface and at least two upstream interfaces, wherein the peripheral component interconnect express slot is used for installing the peripheral component interconnect express device; the downstream interface is used for being connected to the peripheral component interconnect express slot; the at least two upstream interfaces are used for being connected to a central processing unit on the motherboard side, to form a multi-channel data link between the central processing unit and any peripheral component interconnect express slot; the being connected to a central processing unit on a motherboard side comprises: the at least two upstream interfaces are in one-to-one connection with interfaces of a corresponding quantity on the motherboard side; during data transmission, the switching unit selects any channel in the multi-channel data link for data transmission; if a current data channel fails, the current data channel is automatically switched to any of the remaining redundant channels for data transmission; and
the central processing unit, connected to the upstream interfaces of each peripheral component interconnect express expansion chassis through a plurality of peripheral component interconnect express interfaces on the motherboard side respectively, configured to conduct data communication with the peripheral component interconnect express device on the peripheral component interconnect express expansion chassis, and configured to, when any channel in the multi-channel data link fails, disable the peripheral component interconnect express interface of the channel on the motherboard side.

21. The method for controlling data transmission according to claim 15, further comprising:
generating fault information based on all currently faulty channels, and recording fault logs based on the fault information and channel switching information; and
warning of a link fault based on the fault information.
